(19) United States
(12) Patent Application Publication
(10) Pub. No.: US 2020/0410580 A1
(43) Pub. Date: Dec. 31, 2020

(54) INFORMATION PROVIDING APPARATUS, INFORMATION PROVIDING SYSTEM, AND INFORMATION PROVIDING METHOD

(71) Applicant: HONDA MOTOR CO., LTD., Tokyo (JP)

(72) Inventors: Sho Takada, Wako-shi (JP); Nobuyuki Sasaki, Wako-shi (JP); Mitsuhiro Ito, Wako-shi (JP); Mio Oshima, Wako-shi (JP); Ryo Oshima, Wako-shi (JP); Yoshihiro Matsunaga, Wako-shi (JP)

(21) Appl. No.: 17/017,250

(22) Filed: Sep. 10, 2020

Related U.S. Application Data
(63) Continuation of application No. PCT/JP2018/043826, filed on Nov. 28, 2018.

(30) Foreign Application Priority Data
Mar. 20, 2018 (JP) 2018-052591

(51) Int. Cl. G06Q 30/06; G06F 16/23; G06F 16/25; B60L 53/10; B60L 53/30; B60L 53/53; B60L 53/54; B60L 53/62; B60L 53/66; B60K 6/28

(52) U.S. Cl. CPC G06Q 30/0645; G06Q 30/0639; G06Q 30/0625; G06F 16/2379; G06F 16/252; B60L 53/10; H02J 7/02; B60L 53/53; B60L 53/54; B60L 53/62; B60L 53/665; B60K 6/28; B60L 53/305

(57) ABSTRACT

An information providing apparatus receives an information request concerning a lendable movable external power feeding apparatus (power feeder) for supplying electric power from a terminal via a network, provides, by communicating with such a power feeder via the network, lending/borrowing information acquired from a database for managing information including an electric power supply capability, a current location, and a weight of the power feeder, an identifier for specifying the power feeder, and lending/borrowing information of the power feeder, acquires information concerning a lending price of the power feeder set by the owner in response to the information request, and edits information to be provided to the terminal, based on the acquired information and transmits the edited information to the terminal via the network.

### CROSS-REFERENCE TO RELATED APPLICATION(S)

This application is a continuation of International Patent Application No. PCT/JP2018/043826 filed on Nov. 28, 2018, which claims priority to and the benefit of Japanese Patent Application No. 2018-052591 filed on Mar. 20, 2018, the entire disclosures of which are incorporated herein by reference.

### BACKGROUND OF THE INVENTION

### Field of the Invention

The present invention relates to an information providing apparatus, an information providing system, and an information providing method and, more particularly, to an information providing apparatus, an information providing system, and an information providing method for providing, for example, the arrangement situation of external power feeding apparatuses to a user via a network.

### Description of the Related Art

There has conventionally been proposed a system that provides, to a user who needs electric power, for example, a person who is driving an electric vehicle (EV), information about locations of facilities such as charging stations capable of supplying electric power to the electric vehicle. For example, Japanese Patent Laid-Open No. 2013-104680 proposes a system that checks the remaining battery amount of an EV and charging stations reachable using the remaining battery amount and displays the result on the display of the EV.

However, the above-described prior art merely assumes information providing concerning the installation location of infrastructure equipment such as a charging station for an electric vehicle (EV).

Even in an emergency such as an disaster, the necessity of electric power supply always exists. It can be said that the modern society works by electricity. Once electric power supply stops, the function of the society or home itself stops. Even in such a case, a rechargeable battery provided in an electric vehicle (EV) or a plug-in hybrid electric vehicle (PHEV) can function as an electric power supply source.

However, the EV or PHEV is configured to internally supply electric power by a direct current (DC) from a rechargeable battery to each portion of the vehicle, and cannot supply electric power of an alternating current (AC) needed in an office or home. Under such an environment, an external power feeding apparatus (Power Exporter) that transforms a direct current into an alternating current and supplies electric power is necessary such that electric power extracted from the rechargeable battery of an EV or PHEV can be supplied to, for example, home electric appliances. On the other hand, such an external power feeding apparatus is not widespread in general. Hence, there is a demand for a system that acquires information about where an external power feeding apparatus in a lendable state exists and how much electric power supply capability the external power feeding apparatus has, or provides the information.

### SUMMARY OF INVENTION

The present invention has been made in consideration of the above-described prior art, and has as its objective to provide an information providing apparatus, an information providing system, and an information providing method capable of providing information about a lendable external power feeding apparatus.

In order to achieve the above-described objective, an information providing apparatus according to the present invention has the following arrangement.

That is, there is provided an information providing apparatus for providing information via a network in response to a request from a terminal, comprising a reception unit configured to receive, from the terminal via the network, an information request concerning a lendable movable external power feeding apparatus configured to supply electric power, a database configured to manage information including an electric power supply capability, a current location, and a weight of the lendable movable external power feeding apparatus, an identifier for specifying the lendable external power feeding apparatus, and lending/borrowing information of the lendable external power feeding apparatus, an editing unit configured to provide, by communicating with an external power feeding apparatus via the network, the lending/borrowing information acquired by accessing the database in response to the information request, acquire information concerning a lending price of the external power feeding apparatus, and edit, based on the acquired information, information to be provided to the terminal that has issued the information request, and a transmission unit configured to transmit, via the network, the information edited by the editing unit to the terminal that has issued the information request, wherein the lending price is a price set, based on the lending/borrowing information stored in the database, by an owner of the external power feeding apparatus that performs communication via the network.

According to another aspect of the present invention, there is provided an information providing system comprising the above-described information providing apparatus, a terminal connected to the information providing apparatus via a network, and an external power feeding apparatus connected to the information providing apparatus via the network.

According to still another aspect of the present invention, there is provided an information providing method in an information providing apparatus for providing information via a network in response to a request from a terminal, comprising receiving, from the terminal via the network, an information request concerning a lendable movable external power feeding apparatus configured to supply electric power, providing, by communicating with an external power feeding apparatus via the network, lending/borrowing information acquired by accessing a database configured to manage information including an electric power supply capability, a current location, and a weight of the lendable movable external power feeding apparatus, an identifier for specifying the lendable external power feeding apparatus, and lending/borrowing information of the lendable external power feeding apparatus in response to the information request, acquiring information concerning a lending price of the external power feeding apparatus, and editing, based on the acquired information, information to be provided to the terminal that has issued the information request, and transmitting, via the network, the edited information to the terminal that has issued the information request, wherein the lending price is a price set, based on the lending/borrowing information stored in the database, by an owner of the external power feeding apparatus that performs communication via the network.

Hence, according to the arrangements of the above aspects of the present invention, information concerning a lendable external power feeding apparatus can easily be acquired, and the owner of the external power feeding apparatus can set the lending price.

Further features of the present invention will become apparent from the following description of exemplary embodiments (with reference to the attached drawings).

### BRIEF DESCRIPTION OF DRAWINGS

FIG. 1 is a block diagram showing the outline of the arrangement of an information providing system according to a representative embodiment of the present invention;

FIG. 2 is a block diagram showing the arrangement of an external power feeding apparatus;

FIG. 3 is a block diagram showing the schematic arrangement of an information providing apparatus;

FIG. 4A is a view showing lending/borrowing information stored in a database provided in an information providing apparatus;

FIG. 4B is a view showing lending/borrowing information stored in a database provided in an information providing apparatus;

FIG. 5 is a flowchart showing the outline of overall processing of information providing executed by the information providing system;

FIG. 6A is a flowchart showing details of information generation processing; and

FIG. 6B is a flowchart showing details of information generation processing.

### DESCRIPTION OF EMBODIMENTS

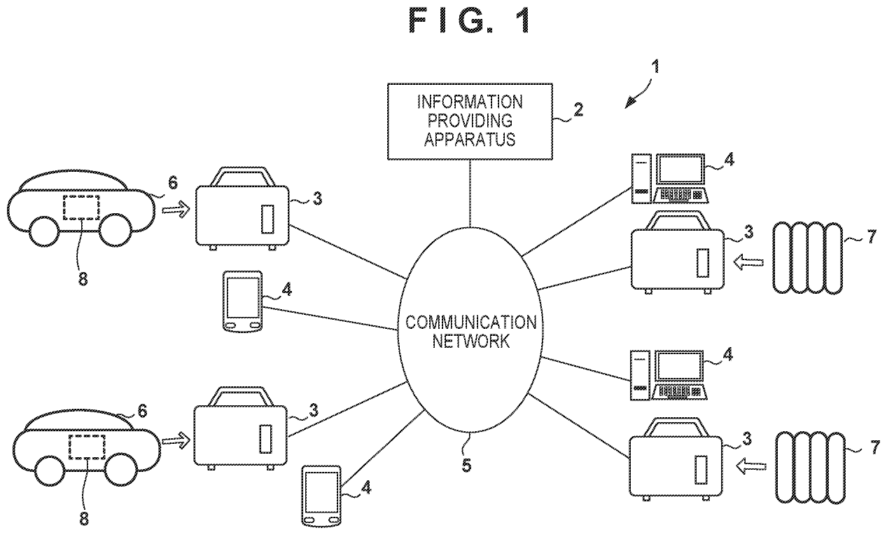

A preferred embodiment of the present invention will now be described in more detail with reference to the accompanying drawings.

<Arrangement of System (FIG. 1)>

FIG. 1 is a block diagram showing the outline of the arrangement of an information providing system 1 according to a representative embodiment of the present invention.

The information providing system 1 shown in FIG. 1 includes, for example, an information providing apparatus 2 communicably connected via a communication network 5 such as the Internet, a plurality of external power feeding apparatuses 3, and a plurality of terminals 4. In the example shown in in FIG. 1, four external power feeding apparatuses 3 are shown, and a number of external power feeding apparatuses 3 can form the system 1.

The information providing apparatus 2 is a computer functioning as an information providing server (to be referred to as a server hereinafter) in the information providing system 1. The external power feeding apparatus 3 is a movable apparatus that receives electric power from an external power feeder and supplies the electric power to an electric appliance. The movable external power feeding apparatus is carried to a use site in accordance with a user's application purpose such as leisure, business, or emergency. The external power feeding apparatus 3 can be either a possession of an individual or a corporation or a rental article.

The terminal 4 is a computer used by a user who needs the external power feeding apparatus 3, and is, for example, a personal computer or a portable terminal such as a smartphone or a tablet. The terminal 4 includes a display or a touch panel, and has a wireless communication function such as WiFi®, Bluetooth®, or LTE. In this embodiment, information to be provided to the user of the terminal 4 is transmitted to the terminal 4 via the information providing apparatus 2 (server). However, depending on the function or installation environment of the external power feeding apparatus 3, the information can directly be transmitted from the external power feeding apparatus 3 to the terminal 4.

In the information providing system 1, the information providing apparatus 2 collects a lending price from the external power feeding apparatus 3 via the communication network 5 such as the Internet and provides the collected information and information including the place, the supply capability, and the weight of the external power feeding apparatus 3 from a database provided in the information providing apparatus 2 to the terminal 4. Based on the provided information, the terminal 4 can understand the type and location of an apparatus preferable for the user who borrows the apparatus.

The external power feeding apparatus 3 can, for example, extract a direct current (DC) from a rechargeable battery 8 mounted in a vehicle 6 such as an EV or a PHEV or from an installed rechargeable battery 7, transform it into an alternating current (for example, AC 100 V), and supply electric power. Hence, if the external power feeding apparatus 3 and a vehicle such as an EV or a PHEV exist, or if the external power feeding apparatus 3 and the rechargeable battery 7 such as an installed fuel cell exist, AC power can be supplied to an electric product in home.

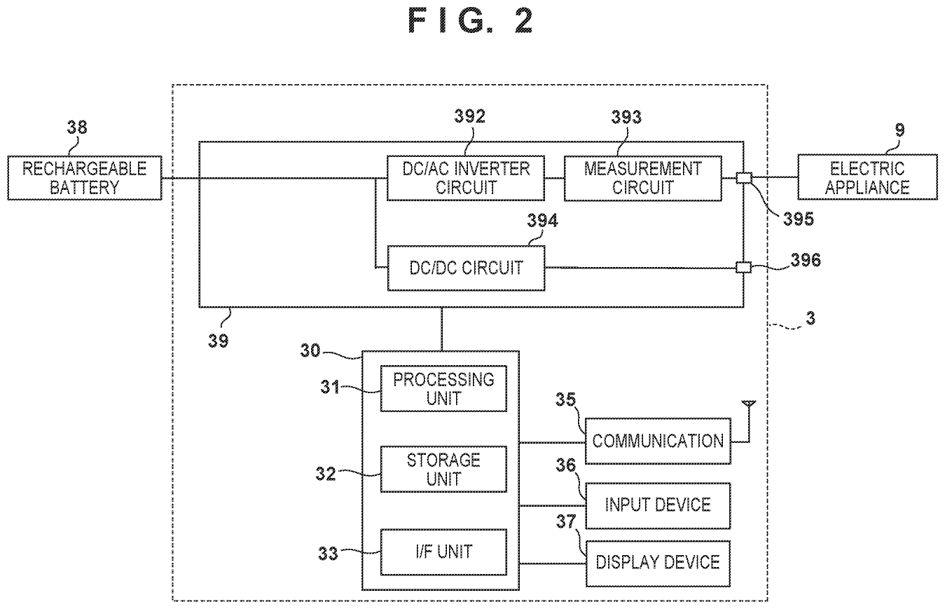

The information providing apparatus 2 can be operated by, for example, a rental trader of the external power feeding apparatus 3. The trader can obtain information concerning the actual state of the availability of the external power feeding apparatus 3 and can use the information as a material for business in the future.

<External Power Feeding Apparatus (FIG. 2)>

FIG. 2 is a block diagram showing the arrangement of the external power feeding apparatus 3.

The external power feeding apparatus 3 according to this embodiment is an external power feeding apparatus that extracts direct current (DC) power from a rechargeable battery 38 and supplies this as alternating current (AC) power to an electric appliance 9. The rechargeable battery 38 corresponds to the rechargeable battery 7 or 8 shown in FIG. 1, and is for example, a secondary battery such as a lithium ion battery, or a fuel cell.

A power supply circuit 39 is a circuit that transforms a DC voltage extracted by the rechargeable battery 38 into a predetermined alternating current or direct current. A DC/AC inverter circuit 392 is a circuit that transforms a direct current supplied from the rechargeable battery 38 into a stable alternating current having a predetermined frequency (for example, 50 Hz). A DC/DC circuit 394 transforms a direct current supplied from the rechargeable battery 38 into a direct current of another voltage and supplies an operating voltage to a control circuit 30 or the like, or outputs the voltage from a DC outlet 396. The electric appliance 9 that can be driven by DC power is detachably connected to the DC outlet 396.

A measurement circuit 393 includes a current sensor and a voltage sensor, measures an AC voltage and an alternating current supplied from the DC/AC inverter circuit 392 to the electric appliance 9 connected to an AC outlet 395, and outputs the measurement result to the control circuit 30. The electric appliance 9 that can be driven by AC power is detachably connected to the AC outlet 395.

If the application purpose of the external power feeding apparatus 3 is leisure, examples of the electric appliance 9 are electric loads such as a cooking device, an air conditioner, a television, a lighting device, and a drier. Examples of cooking devices are an electric griddle, a kettle, a microwave oven, a grill, and a mixer. If the application purpose of the external power feeding apparatus 3 is business, examples are electric loads such as an electric tool, a large lighting device, and a compressor.

In this arrangement, the measurement circuit 393 measures the discharge information and discharge frequency of the rechargeable battery 38, the presence/absence of overdischarge, the remaining amount of the rechargeable battery 38, and the like.

The control circuit 30 is a circuit that controls the external power feeding apparatus 3. The control circuit 30 includes a processing unit 31, a storage unit 32, and an I/F (interface) unit 33. The processing unit 31 is a processor represented by a CPU or an MPU, and executes programs stored in the storage unit (memory) 32. The storage unit 32 is a storage device such as a RAM, a ROM, an SSD (Solid State Disk), or a hard disk. In addition to the programs to be executed by the processing unit 31, various kinds of data are stored in the storage unit 32. The I/F unit 33 relays transmission/reception of signals between an external device and the processing unit 31.

A communication device 35 is a wireless communication device that performs information communication with the information providing apparatus 2 via the communication network 5. Note that the communication device 35 may be a wired communication device. An input device 36 is a device that accepts operation input of the owner of the external power feeding apparatus 3, and includes, for example, a plurality of switches or a piezoelectric touch panel. A display device 37 is a device that displays information to the user of the external power feeding apparatus 3, and is, for example, a light emitting element such as an LCD or an LED.

The processing unit 31 transmits the measurement result of the measurement circuit 393 as the availability information of the external power feeding apparatus 3 to the information providing apparatus 2 by the communication device 35. The measurement result of the measurement circuit 393 can be used as information concerning the type of the electric appliance 9 connected to the AC outlet 395 of the external power feeding apparatus 3, and can particularly be used to estimate the type. Electric power supplied to the electric appliance 9 exhibits a waveform characterized by the type of the electric appliance 9. By this feature amount, the type of the connected electric appliance 9 can also be estimated.

<Another Arrangement Example of External Power Feeding Apparatus>

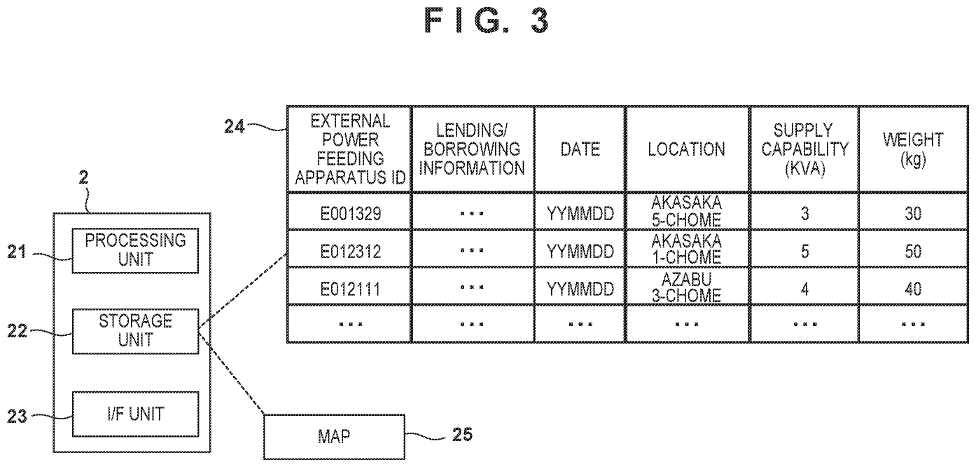

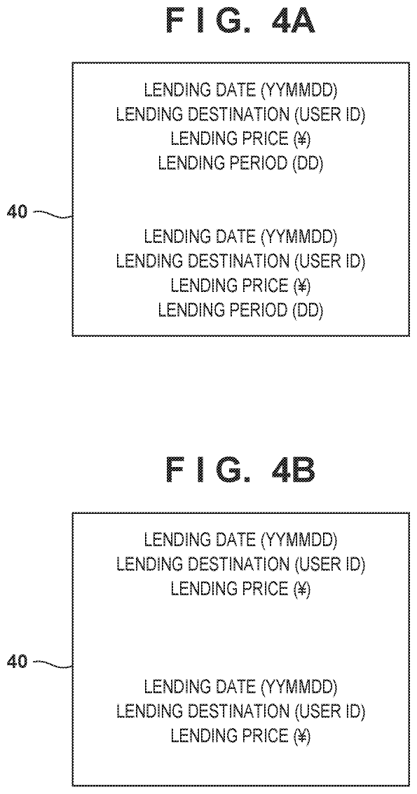

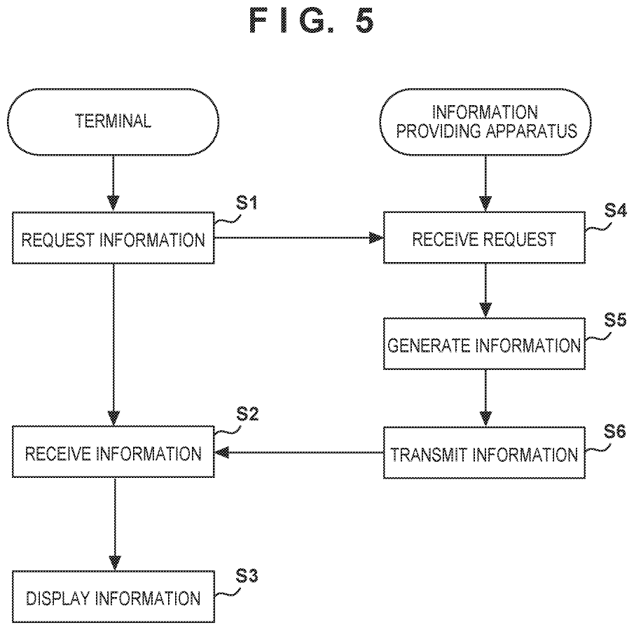

The external power feeding apparatus 3 shown in FIG. 2 uses only the rechargeable battery 38 as an electric power supply source. However, the present invention is not limited by this. For example, both electric power generated by an engine generator and DC power from the rechargeable battery 38 may be input. In this case, the external power feeding apparatus includes a transformer or a transformation circuit configured to transform AC power generated by the engine generator into AC power of a proper voltage.

<Information Providing Apparatus (FIGS. 3 to 4B)%

FIG. 3 is a block diagram showing the schematic arrangement of the information providing apparatus 2.

The information providing apparatus 2 includes a processing unit 21, a storage unit 22, and an I/F (interface) unit 23. The processing unit 21 is a processor represented by a CPU, and executes programs stored in the storage unit 22. The IX unit 23 relays transmission/reception of signals between an external device and the processing unit 21. The I/F unit 23 includes a wired or wireless communication interface capable of communicating with the external power feeding apparatus 3 or the terminal 4 via the communication network 5. The storage unit 22 is a storage device such as a RAM, a ROM, an SSD, or a hard disk.

In addition to the programs to be executed by the processing unit 21, various kinds of data are stored in the storage unit 22. In the example shown in FIG. 3, databases 24 and 25 are shown as the data stored in the storage unit 22. The database 24 is a database that accumulates data concerning the external power feeding apparatus 3.

“External power feeding apparatus ID” is an identifier assigned in advance to specify each external power feeding apparatus 3. “Supply capability” includes information concerning the AC power supply capability, the continuous operable time, and the like of the external power feeding apparatus 3. “Weight” includes the weight of the external power feeding apparatus 3 because it is movable. “Location” indicates the current location of the external power feeding apparatus 3, and “date” indicates the date/time when the external power feeding apparatus 3 was installed in the location represented by “location”. “Lending/borrowing information” includes history information representing the history of lending and borrowing of the external power feeding apparatus 3.

The database 25 is a database that accumulates a map (map information). Based on the position information of a terminal transmitted from the terminal 4, the processing unit 21 collates the position of the external power feeding apparatus 3, which is to be provided to the terminal 4, with the map information and provides accurate position information to the user of the terminal 4.

FIGS. 4A and 4B are views showing lending/borrowing information stored in the database 24 provided in the information providing apparatus 2.

In the database 24, lending/borrowing information is managed for each external power feeding apparatus.

The lending/borrowing information is generated every time lending is performed once, and the lending/borrowing history is accumulated. The format of the lending/borrowing history is not limited to one formal, as shown in FIGS. 4A and 4B. As shown in FIG. 4B, every time lending occurs, at least pieces of information of the lending date, lending destination, and lending price are generated and stored time-serially. In addition to these pieces of information, a lending period may be stored, as shown in FIG. 4A.

Note that as for the arrangement of the portable terminal 4, an off-the-shelf portable terminal suffices, and a description thereof will be omitted. However, it is assumed that an application configured to cause the user to acquire the information of the external power feeding apparatus via the network is downloaded in the portable terminal. In addition, the portable terminal can acquire its position information via a GPS. Map information is provided from the information providing apparatus 2 or another information supply source, and the portable terminal can display a map and the position information. Furthermore, the terminal 4 can transmit its position information based on the GPS to the information providing apparatus 2.

Processing of providing information of a lendable external power feeding apparatus, which is executed by the information providing system with the above-described arrangement, will be described next with reference to a flowchart.

<Processing Examples>

FIG. 5 is a flowchart showing the outline of overall processing of information providing executed by the information providing system 1.

According to FIG. 5, first, in step S1, the user of the terminal 4 activates the application, and requests the information providing apparatus (server) 2 to provide the information of a lendable external power feeding apparatus via the communication network 5. The request includes the position information of the terminal 4 itself. For the request, the information providing apparatus 2 receives the request in step S4, and generates information to be provided to the terminal 4 in step SS. In step S6, the generated information is transmitted to the terminal 4 that has transmitted the request via the communication network 5.

On the other hand, the terminal 4 receives the transmitted information in step S2, and displays the received information (the information of the lendable external power feeding apparatus) in step S3. In this information display, the positions, electric power supply capabilities, lending prices, and the like of (a plurality of) external power feeding apparatuses that exist in the neighborhood of the terminal 4 and are lendable are displayed in a table format on the display of the terminal 4.

In addition, if the terminal 4 can display a map based on the map information, the position of the terminal 4 itself and the positions of lendable external power feeding apparatuses existing in the neighborhood may be displayed on the map. When the icon of a displayed external power feeding apparatus is tapped, pieces of detailed information such as the accurate position, the electric power supply capability, and the lending price of the tapped external power feeding apparatus are preferably displayed.

Generation processing of information to be provided to the terminal, which is executed by the information providing apparatus 2, will be described next.

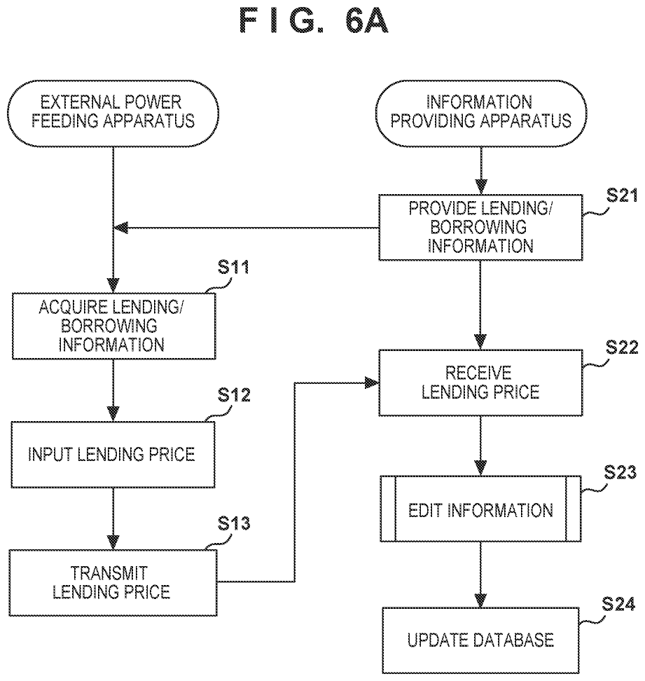

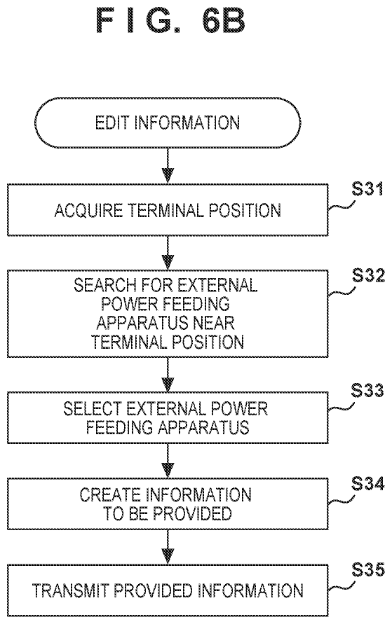

FIGS. 6A and 6B are flowcharts showing details of information generation processing.

According to FIG. 6A, upon receiving an information request in step S4 shown in FIG. 5, the information providing apparatus 2 accesses the database 24 in step S21 to acquire lending/borrowing information concerning various external power feeding apparatuses, and provides the lending/borrowing information to the external power feeding apparatus 3 via the communication network 5. The provided lending/borrowing information includes a lending price, a lending period, and the like as shown in FIG. 4A.

As the external power feeding apparatus to which the ending/borrowing information is provided, an external power feeding apparatus located near the terminal 4 is preferably selected based on the place of the external power feeding apparatus stored in the database 24 in advance and the position information of the terminal 4 that has issued the information request. Instead of making such selection, all external power feeding apparatuses managed by the database 24 may be selected as targets.

In step S11, the external power feeding apparatus 3 acquires the provided lending/borrowing information, and displays the acquired lending/borrowing information on the display device 37 of the external power feeding apparatus 3. In step S12, the owner of the external power feeding apparatus 3 inputs a lending price desired by him/her based on the displayed lending/borrowing information. In step S13, the lending price input by the owner is transmitted to the information providing apparatus 2 via the communication network 5.

On the other hand, in step S22, the information providing apparatus 2 receives the transmitted lending price. In step S23, based on the received information, the information providing apparatus 2 edits information to be transmitted to the terminal 4 that has issued the information request.

In this information editing, as shown in FIG. 6B, in step S31, the position information of the terminal 4 that has issued the information request is acquired. Also, in step S32, an external power feeding apparatus located near the terminal 4 is searched for. In step S33, an external power feeding apparatus as the target of information to be transmitted to the terminal 4 is selected.

In step S34, information to be provided to the terminal 4 is created based on the processes of steps S31 to S33. In step S35, the provided information is transmitted to the terminal 4. The provided information includes the external power feeding apparatuses selected in step S33 and the position information, the lending price, the electric power supply capability, and the weight of each apparatus.

Referring back to FIG. 6A, when the information editing in step S23 ends, in step S24, the information, particularly, the lending/borrowing information in the database 24 is updated to the latest state.

Hence, according to the above-described embodiment, in the information providing system, an external power feeding apparatus located near the terminal and the position, the lending price, and the electric power supply capability of the external power feeding apparatus can be notified in accordance with a request from the terminal. The terminal can display the notified information in a table format or on a map. This allows the user of the terminal to easily acquire information concerning a lendable external power feeding apparatus.

Note that in the above-described embodiment, the lending price of the external power feeding apparatus is set by the owner of the external power feeding apparatus. However, the present invention is not limited to this. For example, in a system in which the information providing apparatus 2 is owned and managed by a rental trader, and the external power feeding apparatus is also a possession of the rental trader, it is not necessary to inquire of the owner of the external power feeding apparatus about the lending price. In this case, the lending price may be set in advance in the database 24, and the information providing apparatus may directly provide information in response to the information request from the user of the terminal using the set lending price.

[Summary of Embodiment]

Arrangement 1.

An information providing apparatus (2) for providing information via a network (5) in response to a request from a terminal (4), comprises a reception unit (23) configured to receive, from the terminal via the network, an information request (S1) concerning a lendable movable external power feeding apparatus (3) configured to supply electric power, a database (24) configured to manage information including an electric power supply capability, a current location, and a weight of the lendable movable external power feeding apparatus, an editing unit (21) configured to edit, based on information acquired by accessing the database in response to the information request, information to be provided to the terminal that has issued the information request, and a transmission unit (23) configured to transmit, via the network, the information edited by the editing unit to the terminal that has issued the information request.

Arrangement 2.

The information request received by the reception unit includes information representing a position of the terminal that has issued the information request.

Arrangement 3.

The information edited by the editing unit includes a position, a lending price, and an electric power supply capability concerning each lendable movable external power feeding apparatus (3) located near the terminal that has issued the information request.

Arrangement 4.

The database (24) further stores an identifier for specifying each lendable external power feeding apparatus (3), and lending/borrowing information of each lendable external power feeding apparatus.

Arrangement 5.

The information providing apparatus further comprises an acquisition unit (35) configured to provide, by communicating with the external power feeding apparatus (3) via the network (5), the lending/borrowing information in response to the information request (S1), and acquire information concerning a lending price of the external power feeding apparatus, wherein the lending price is a price set, based on the lending/borrowing information stored in the database, by an owner of the external power feeding apparatus that performs communication via the network.

Arrangement 6.

The lending/borrowing information is history information accumulated every time lending is performed, and the history information includes the lending price and a lending period.

Arrangement 7.

The external power feeding apparatus transforms a direct current supplied from a rechargeable battery (7, 8) into an alternating current, and the rechargeable battery includes one of a secondary battery mounted in a vehicle (6) including an EV and a PHEV and a fuel cell.

Arrangement 8.

An information providing system (1) comprises an information providing apparatus (2) of any one of Arrangements 1 to 7, a terminal (4) connected to the information providing apparatus via a network (5), and an external power feeding apparatus (3) connected to the information providing apparatus via the network.

Arrangement 9.

An information providing method in an information providing apparatus (2) for providing information via a network (5) in response to a request from a terminal (4), comprises: receiving (S1), from the terminal via the network, an information request concerning a lendable movable external power feeding apparatus configured to supply electric power, editing (S23), based on information acquired by accessing a database configured to manage information including an electric power supply capability, a current location, and a weight of the lendable movable external power feeding apparatus in response to the information request, information to be provided to the terminal that has issued the information request, and transmitting (S35), via the network, the edited information to the terminal that has issued the information request.

According to Arrangement 1 to Arrangement 9 described above, it is possible to provide information concerning the lendable external power feeding apparatus via the network.

According to Arrangement 2 to Arrangement 3 described above, it is possible to provide information including the lending price and the electric power supply capability of the external power feeding apparatus located near the terminal of the information request source.

According to Arrangement 7 described above, the lendable external power feeding apparatus can use a secondary battery mounted in a vehicle, a fuel cell, or the like as the electric power supply source.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An information providing apparatus for providing information via a network in response to a request from a terminal, comprising:
a reception unit configured to receive, from the terminal via the network, an information request concerning a lendable movable external power feeding apparatus configured to supply electric power;
a database configured to manage information including an electric power supply capability, a current location, and a weight of the lendable movable external power feeding apparatus, an identifier for specifying the lendable external power feeding apparatus, and lending/borrowing information of the lendable external power feeding apparatus;
an editing unit configured to provide, by communicating with an external power feeding apparatus via the network, the lending/borrowing information acquired by accessing the database in response to the information request, acquire information concerning a lending price of the external power feeding apparatus, and edit, based on the acquired information, information to be provided to the terminal that has issued the information request; and
a transmission unit configured to transmit, via the network, the information edited by the editing unit to the terminal that has issued the information request,
wherein the lending price is a price set, based on the lending/borrowing information stored in the database, by an owner of the external power feeding apparatus that performs communication via the network.

2. The information providing apparatus according to claim 1, wherein the information request received by the reception unit includes information representing a position of the terminal that has issued the information request.

3. The information providing apparatus according to claim 2, wherein the information edited by the editing unit includes a position, a lending price, and an electric power supply capability concerning each lendable movable external power feeding apparatus located near the terminal that has issued the information request.

4. The information providing apparatus according to claim 1, wherein the lending/borrowing information is history information accumulated every time lending is performed, and
the history information includes the lending price and a lending period.

5. The information providing apparatus according to claim 1, wherein the external power feeding apparatus transforms a direct current supplied from a rechargeable battery into an alternating current, and
the rechargeable battery includes one of a secondary battery mounted in a vehicle including an EV and a PHEV and a fuel cell.

6. An information providing system comprising:
an information providing apparatus;
a terminal connected to the information providing apparatus via a network; and
an external power feeding apparatus connected to the information providing apparatus via the network, wherein
the information providing apparatus provides information via the network in response to a request from the terminal, and
the information providing apparatus comprises:
a reception unit configured to receive, from the terminal via the network, an information request concerning a lendable movable external power feeding apparatus configured to supply electric power;
a database configured to manage information including an electric power supply capability, a current location, and a weight of the lendable movable external power feeding apparatus, an identifier for specifying the lendable external power feeding apparatus, and lending/borrowing information of the lendable external power feeding apparatus;
an editing unit configured to provide, by communicating with an external power feeding apparatus via the network, the lending/borrowing information acquired by accessing the database in response to the information request, acquiring information concerning a lending price of the external power feeding apparatus, and editing, based on the acquired information, information to be provided to the terminal that has issued the information request; and
a transmission unit configured to transmit, via the network, the information edited by the editing unit to the terminal that has issued the information request, and
wherein the lending price is a price set, based on the lending/borrowing information stored in the database, by an owner of the external power feeding apparatus that performs communication via the network.

7. An information providing method in an information providing apparatus for providing information via a network in response to a request from a terminal, comprising:
receiving, from the terminal via the network, an information request concerning a lendable movable external power feeding apparatus configured to supply electric power;
providing, by communicating with an external power feeding apparatus via the network, lending/borrowing information acquired by accessing a database configured to manage information including an electric power supply capability, a current location, and a weight of the lendable movable external power feeding apparatus, an identifier for specifying the lendable external power feeding apparatus, and lending/borrowing information of the lendable external power feeding apparatus in response to the information request, acquiring information concerning a lending price of the external power feeding apparatus, and editing, based on the acquired information, information to be provided to the terminal that has issued the information request; and
transmitting, via the network, the edited information to the terminal that has issued the information request,
wherein the lending price is a price set, based on the lending/borrowing information stored in the database, by an owner of the external power feeding apparatus that performs communication via the network.
